(19) United States
(12) Patent Application Publication
(10) Pub. No.: US 2006/0045173 A1
(43) Pub. Date: Mar. 2, 2006

(54) Method and apparatus for improving upstream pulse code modulation connect rates of an analog modem

(75) Inventors: Vikram Phogat, Bangalore (IN); Narasimha Pai, Bangalore (IN)

Correspondence Address: DILLON & YUDELL LLP, 8911 NORTH CAPITAL OF TEXAS HWY, SUITE 2110, AUSTIN, TX, 78759, US

(73) Assignees: ITTIAM SYSTEMS (P) LTD.; SILICON LABORATORIES, INC.

(21) Appl. No.: 10/930,093

(22) Filed: Aug. 31, 2004

(51) Int. Cl. H04B 1/38

(52) U.S. Cl. 375/222

(57) ABSTRACT

A method and apparatus for improving upstream connect rates of an analog modem are provided. The analog modem includes a modem transmitter, a modem receiver, a transmitter re-sampler, a receiver re-sampler and a codec. A sampling rate converter is provided between the modem transmitter and the transmitter re-sampler. The sampling rate converter changes the input sampling rate to the transmitter re-sampler by a factor equal to the ratio of the sampling rate of analog modem codec to the symbol rate of the modem transmitter in order to avoid attenuation in the transmitter re-sampler. The transmitter clock is synchronized with the codec sampling clock in a central office. The transmitter re-sampler corrects the clock difference between the sampling clocks of modem codec and central office codec.

The present patent application is related to a copending application U.S. Ser. No. ______, filed on even date, entitled “METHOD AND APPARATUS FOR SYNCHRONIZING A TRANSMITTER CLOCK OF AN ANALOG MODEM TO A REMOTE CLOCK” (Attorney Docket No. SILA0013), the pertinent of which is incorporated herein by reference.

### BACKGROUND OF THE INVENTION

1. Technical Field

The present invention relates to data communications in general, and in particular to data communications utilizing modems. Still more particularly, the present invention relates to a method and apparatus for improving upstream connect rates of a V.92 analog modem.

2. Description of Related Art

Voice band modems are commonly used to transmit data over telephone lines. Conventional voice band modems are designed to use a public switched telephone network (PSTN) as an analog communication channel. However, modern PSTNs typically utilize digital links to connect to server modems. Thus, most of the server modems are connected to the PSTN via digital links, and only client modem connections to the PSTN are made via analog subscriber lines.

According to the International Telecommunication Union (ITU), voice band modems are designated as “V.” series of modems. Pulse code modulated (PCM) modems, such as ITU-T V.90 and V.92 modems, can take advantage of the digital portion of the PSTN and use PCM transmissions to obtain relatively high data rates. V.90 and V.92 server modems are connected to the digital portion of a PSTN, and hence are called digital modems. V.90 and V.92 client modems are connected to the analog portion of a PSTN, and hence are called analog modems.

V.90 modems support data rates up to 56 kbps in downstream transmissions, which are server-to-client transmissions, and 33.6 kbps in upstream transmissions, which are client-to-server transmissions. V.90 modems use PCM transmissions for downstream transmissions and quadrature amplitude modulated (QAM) transmissions for upstream transmissions.

During V.90 downstream transmissions from a digital modem to an analog modem, the digital modem transmits 8-bit words that correspond to the different levels of a central office (CO) codec output. In turn, the CO codec converts the eight bit words into analog voltage levels on an analog subscriber line. An analog modem samples the analog voltage levels on the analog subscriber line, equalizes the voltage levels to remove the distortions caused by the analog channel, and then maps the voltage levels back to the originally transmitted eight bit words. PCM transmission is possible in the downstream direction because there is no quantization loss at the CO. PCM transmissions are not possible when there is an analog link between two COs.

ITU-T V.92 modem standard is an enhancement to the ITU-T V.90 modem standard for V.90 modems. V.92 modems are capable of using PCM transmissions for both upstream and downstream transmissions. Downstream transmissions for V.92 modems are basically the same as V.90 modems. For upstream transmissions, a V.92 analog modem transmits a set of analog voltage levels on an analog subscriber line, which is then modified by an analog channel. The CO codec samples the voltage levels and converts them into eight bit words. V.92 modems can support data rates up to 48 kbps in upstream transmissions. In order to take full advantage of the digital link for achieving the best performance in upstream transmissions, quantization losses at the CO codec should be minimized. As such, the analog voltage levels received at the sampling instant of the CO codec should be very close to the fixed sampling levels of the CO codec.

In order to allow the analog voltage levels received at the sampling instant of a CO codec to be very close to the fixed sampling levels of the CO codec, a V.92 analog modem pre-equalizes its transmit channel at its transmitter and synchronizes its transmitter clock to a sampling clock of the CO codec. A re-sampler can be inserted in a transmit path of the V.92 modem for synchronizing the transmitter sampling clock to the sampling clock of the CO. However, when the re-sampler input sampling rate equals the V.92 modem transmitter symbol rate, the re-sampler has a high attenuation at half the transmitter symbol rate. As a result, the upstream connect rate is reduced.

Consequently, it would be desirable to provided a method and apparatus for improving the upstream connect rates of a V.92 modem.

### SUMMARY OF THE INVENTION

In accordance with a preferred embodiment of the present invention, a fixed sampling rate converter (SRC) is added between a modem transmitter and a transmitter re-sampler of an analog modem. The SRC changes the sampling rate from the symbol rate of the modem transmitter to the sampling rate of modem codec without yielding any attenuation in spectrum of zero to half the symbol rate. For example, the sampling rate may be converted from 8000 samples per second to 9600 samples per second, which prevents attenuations in the frequency band of 0 to 4 kHz.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a public switched telephone network environment to which a preferred embodiment of the present invention is applicable; and

FIG. 2 is a detailed block diagram of various components within the public switched telephone network from FIG. 1, in accordance with a preferred embodiment of the present invention.

### DETAILED DESCRIPTION OF A PREFERRED EMBODIMENT

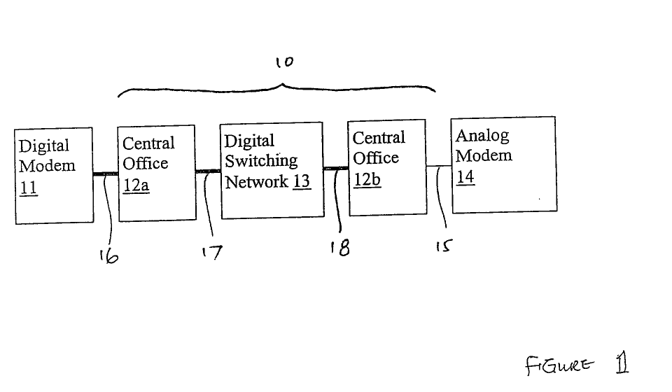

The present invention provides a method and apparatus for improving upstream connect rates of a V.92 analog modem. Referring now to the drawings and in particular to FIG. 1, there is depicted a block diagram of a PTSN in which a preferred embodiment of the present invention is incorporated. As shown, a digital modem 11 is connected to a CO 12a of a PSTN 10 via a digital link 16. CO 12a is connected to a digital switching network 13 via a digital link 17. A CO 12b is also connected to digital switching network 13 via a digital link 18. An analog modem 14 is connected to CO 12b through an analog channel 15. Analog channel 15, which corresponds to an individual analog subscriber line, is the only analog link within PSTN 10. Thus, PTSN 10 preferably includes:
i. digital modems connected to central offices via digital links;
ii. analog modems connected to central offices via analog links; and
iii. a digital switching network.
   Digital modem 11, which is preferably used at an Internet service provider location, can be referred to as a server modem. Analog modem 14, which is preferably used at an end user terminal, can be referred to as a client modem.

A transmitter re-sampler is inserted in a transmit path of analog modem 14 between a transmitter and a codec in order to provide transmitter clock synchronizations. Similarly, a receiver re-sampler is inserted in a receive path of analog modem 14 between a receiver and the codec. The transmitter re-sampler and receiver re-sampler receive inputs from a clock recovery module.

Some definitions used in the present specification are:
F_{C}—sampling rate of an analog modem codec
F_{S}—symbol rate of an analog modem receiver and transmitter
ΔF_{S}—estimated difference between the symbol rate of an analog modem and a CO clock
F_{STX}—default sampling rate of an analog modem transmitter re-sampler
F_{SRX}—default sampling rate of an analog modem receiver re-sampler
F_{SRX}+ΔF_{SRX}—estimated receiver-sampling rate used by an analog modem receiver re-sampler to synchronize a receiver clock to a CO codec clock
F_{STX}+ΔF_{STX}—estimated transmitter-sampling rate used by an analog modem transmitter re-sampler to synchronize a transmitter clock to a CO codec clock

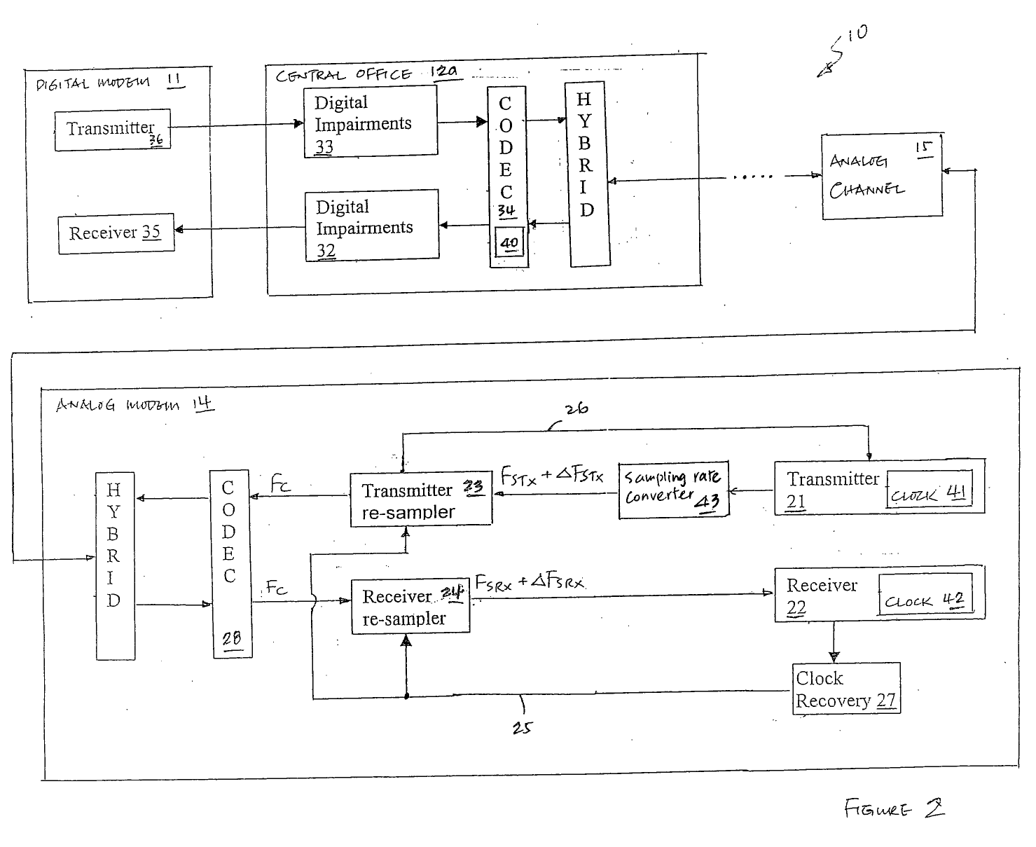

With reference now to FIG. 2, there is depicted a detailed block diagram of various components within public switched telephone network 10 from FIG. 1, in accordance with a preferred embodiment of the present invention. As shown, analog modem 14 is connected to digital modem 11 through analog channel 15 and CO 12a. Analog modem 14 includes a V.92 analog modem transmitter 21 and a V.92 analog modem receiver 22 for performing PCM transmissions in both upstream and downstream directions (i.e., transmitting and receiving, respectively). Analog modem 14 can transmit linear PCM samples in an upstream direction. PCM transmissions in the upstream direction are made possible by synchronizing a transmitter clock 41 within modem transmitter 21 to a clock 40 within CO 12a. V.92 analog modem receiver 22 is quite similar to a V.90 analog modem receiver. However, V.92 analog modem transmitter 21 is very different from a V.90 analog modem transmitter. Modem transmitter 21 transmits pulse-amplitude modulated (PAM) signals and synchronizes its samples with clock 40 in CO 12a. In contrast, a V.90 analog modem transmitter transmits quadrature-amplitude modulated (QAM) signals and does not perform any clock synchronization.

For downstream data receptions, modem receiver 22 synchronizes a receiver clock 42 with clock 40 in CO 12a using a clock estimate 25 generated by a clock recovery module 27. A receiver re-sampler 24 uses clock estimate 25 to re-sample the received samples at a rate proportionate to clock 40 in CO 12a. Clock estimate 25 is also used by modem transmitter 21 to synchronize transmitter clock 41 to clock 40 in CO 12a.

Digital modem 11 includes a transmitter 36 and a receiver 35. Receiver 35 estimates an initial phase error between analog modem transmit clock 41 and clock 40 in CO 12a during the V.92 handshake procedure. Such estimate of the initial phase error is transmitted back to analog modem 14, and transmitter re-sampler 23 corrects the initial phase error during the V.92 handshake procedure. After the initial phase error has been corrected, modem transmitter 21 starts deriving transmitter clock 41 from modem receiver 22.

Analog modem 14 includes a modem codec 28 that operates at a rate higher than a symbol rate F_{S} used in modem transmitter 21 and modem receiver 22. Transmitter re-sampler 23 and receiver re-sampler 24 synchronize transmitter clock 41 and receiver clock 42, respectively, to clock 40 in CO 12a. Transmitter re-sampler 23 and receiver re-sampler 24 are preferred implemented as sync interpolators where re-samplings are performed by interpolations and decimations.

The basic difference between receiver re-sampler 24 and transmitter re-sampler 23 is that, for receiver re-sampler 24, the input sampling frequency F_{C} is fixed while the output sampling frequency F_{SRX}+ΔF_{SRX} varies, and for transmitter re-sampler 23, the input sampling frequency F_{STX}+ΔF_{STX} varies while the output sampling frequency F_{C} is fixed. To ensure that modem codec 28 always has samples to transmit at its sampling instant, transmitter re-sampler 23 controls the transmitter-processing rate using a control path 26. Control path 26 ensures that modem transmitter 21 is transmitting symbols at a rate equal to the estimated CO codec sampling rate, i.e., F_{STX}+ΔF_{STX}.

The sampling rate F_{C} of modem codec 28 is greater than the symbol rate F_{S} of modem transmitter 21 and modem receiver 22, i.e., F_{C}>F_{S}. The sampling rate F_{SRX} at which modem receiver 22 receives samples from receiver re-sampler 24 is greater than the symbol rate F_{S} of modem receiver 22, i.e., F_{SRX}>F_{S}. When analog modem 14 is using PCM transmissions in the upstream direction as in case of a V.92 analog modem, then the sampling rate F_{STX} of modem transmitter 21 is equal to or greater than the symbol rate F_{S} of modem transmitter 21, i.e., F_{STX}≧F_{S}.

Modem transmitter 21 uses the estimated sampling rate F_{SRX}+ΔF_{SRX} of modem receiver 22 to synchronize its sampling rate with the sampling rate of CO codec 34. In order to accomplish such, modem transmitter 21 needs to generate samples at F_{S}+ΔF_{S} and then converts the sampling rate from F_{S}+ΔF_{S} to F_{C}. Transmitter re-sampler 23 can be used for such purpose. If a single re-sample is used, then F_{STX}=F_{S} and transmitter re-sampler 23 converts the sampling rate from F_{STX}+ΔF_{STX} to F_{C}. However, transmitter re-sampler 23 also yields an attenuation in the order of 6 dB at half the input sampling rate, i.e., (F_{STX}+ΔF_{STX})/2, which is around 4 kHz as F_{STX}=F_{S} for the present example. Since the V.92 transmit spectrum occupies the entire band of 0 to F_{S}/2 Hz, such an attenuation would reduce the upstream connect rates and decrease the throughput.

In order to overcome the above-mentioned problem, a fixed sampling rate converter (SRC) 43 is added between the V.92 analog modem transmitter and transmitter re-sampler 23. SRC 43 performs a fixed rate conversion by a factor F_{C}/F_{S} of the input sampling rate. Sampling rate of modem codec 28 is greater that the symbol rate of transmitter 21. SRC 43 is preferably implemented with a low-pass filter designed to yield an almost flat response until the half of input signal sampling frequency, which is close to F_{S}/2 Hz (i.e., 4 kHz for the present example). Since SRC 43 changes the input sampling rate by a factor F_{C}/F_{S}, the default input sampling rate F_{STX} of transmitter re-sampler 23 now becomes equals to F_{C}. Transmitter re-sampler 23 now has a 6 dB attenuation at (F_{STX}+ΔF_{STX})/2=F_{C}/2 (ΔF_{STX} is very small compare to F_{STX} because sampling clock oscillators used in a CO and analog modems are usually accurate to an order of 100 ppm). F_{C} is chosen sufficiently greater than F_{S} so that re-sampler gain in the spectrum of 0 to F_{S}/2 Hz remains close to unity.

The V.92 transmit spectrum occupies 0 to 4 kHz. If F_{C}=9600 symbols/second and F_{S}=8000 symbols/second, then F_{C}/2=4.8 kHz and F_{S}/2=4 kHz. For the present example, re-sampler 23 is designed to yield unity gain in the spectrum of 0 to 4 kHz and an attenuation of 6 dB at 4.8 kHz. As the 6 dB attenuation now takes place above a transmit spectrum edge value of 4 kHz, there is no attenuation in the band edge component.

As has been described, the present invention provides a method and apparatus for improving upstream connect rates of a V.92 analog modem. With the present invention, a transmitter re-sampler can perform synchronizations of an analog transmitter to a CO clock at improved connect rates because of no attenuation occurred in the transmit spectrum.

It is also important to note that although the present invention has been described from a hardware perspective, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for improving upstream connect rates of an analog modem having a modem transmitter, a modem receiver, a transmitter re-sampler and a receiver re-sampler, said method comprising:
connecting a sampling rate converter between said modem transmitter and said transmitter re-sampler, wherein said transmitter re-sampler re-samples a plurality of transmitter signals from said modem transmitter to said modem codec; and
converting a sampling rate of said of plurality of transmitter signals from a symbol rate of said modem transmitter to a sampling rate of said modem codec.

2. The method of claim 1, wherein said sampling rate converter is a low-pass filter capable of providing a flat response until a frequency of half of a symbol rate used in said modem transmitter.

3. The method of claim 1, wherein said transmitter re-sampler re-samples said plurality of transmitter signals via interpolation and decimation.

4. The method of claim 1, wherein said analog modem is a V.92 modem.

5. A computer program product residing on a computer usable medium for improving upstream connect rates of an analog modem having a modem transmitter, a modem receiver, a transmitter re-sampler and a receiver re-sampler, said computer program product comprising:
program code means for connecting a sampling rate converter between said modem transmitter and said transmitter re-sampler, wherein said transmitter re-sampler re-samples a plurality of transmitter signals from said modem transmitter to said modem codec; and
program code means for converting a sampling rate of said of plurality of transmitter signals from a symbol rate of said modem transmitter to a sampling rate of said modem codec.

6. The computer program product of claim 5, wherein said sampling rate converter is a low-pass filter capable of providing a flat response until a frequency of half of a symbol rate used in said modem transmitter.

7. The computer program product of claim 5, wherein said transmitter re-sampler re-samples said plurality of transmitter signals via interpolation and decimation.

8. The computer program product of claim 5, wherein said analog modem is a V.92 modem.

9. An apparatus for improving upstream connect rates of an analog modem having a modem transmitter, a modem receiver, a transmitter re-sampler and a receiver re-sampler, said computer program product comprising:
means for connecting a sampling rate converter between said modem transmitter and said transmitter re-sampler, wherein said transmitter re-sampler re-samples a plurality of transmitter signals from said modem transmitter to said modem codec; and
means for converting a sampling rate of said of plurality of transmitter signals from a symbol rate of said modem transmitter to a sampling rate of said modem codec.

10. The apparatus of claim 9, wherein said sampling rate converter is a low-pass filter capable of providing a flat response until a frequency of half of a symbol rate used in said modem transmitter.

11. The apparatus of claim 9, wherein said transmitter re-sampler re-samples said plurality of transmitter signals via interpolation and decimation.

12. The apparatus of claim 9, wherein said analog modem is a V.92 modem.
